(19) United States
(12) Patent Application Publication
(10) Pub. No.: US 2018/0047003 A1
(43) Pub. Date: Feb. 15, 2018

(54) CHECKOUT APPARATUS, CHECKOUT METHOD, AND NON-TRANSITORY STORAGE

(71) Applicant: NEC CORPORATION, Tokyo (JP)

(72) Inventor: Takahiro MATSUI, Tokyo (JP)

(73) Assignee: NEC CORPORATION, Tokyo (JP)

(21) Appl. No.: 15/559,849

(22) PCT Filed: Jan. 25, 2016
(86) PCT No.: PCT/JP2016/051968

§ 371 Date: Sep. 20, 2017

(30) Foreign Application Priority Data
Mar. 23, 2015 (JP) 2015-059434

(51) Int. Cl. G06Q 20/20

(52) U.S. Cl. CPC G06Q 20/20

(57) ABSTRACT

The invention provides a checkout apparatus (1) including a product identification information reception unit (10) that receives an input of identification information of a product, a determination unit (20) that determines whether or not a customer satisfies an age requirement by analyzing an image obtained by photographing the customer when the identification information of an age restricted product is input, and a notification unit (30) that outputs a warning for prompting age verification in a case where the determination unit (20) determines that the customer does not satisfy the age requirement and does not output the warning in a case where the determination unit (20) determines that the customer satisfies the age requirement.

### TECHNICAL FIELD

The present invention relates to a checkout apparatus, a checkout method, and a program.

### BACKGROUND ART

Patent Document 1 discloses a product sales data processing apparatus. The product sales data processing apparatus divides facial feature values of a plurality of persons into minor facial feature data and adult facial feature data and holds the data obtained by the division in advance. When a product code of an age restricted product is input, the product sales data processing apparatus collates a purchaser's face image with the feature data. The product sales data processing apparatus stops the sale of the age restricted product in a case where the purchaser's face image is verified as minor facial feature data.

### RELATED DOCUMENT

### Patent Document

[Patent Document 1] Japanese Laid-open Patent Publication No. 2014-32538

### SUMMARY OF THE INVENTION

### Technical Problem

The accuracy of estimation of an age estimation technique by image analysis has been improved. However, it is difficult to obtain one-hundred percent accuracy in the estimation.

In a case of the product sales data processing apparatus disclosed in Patent Document 1, an adult purchaser may be determined to be a minor by mistake, and thus there is a concern that the sale of an age restricted product to the purchaser may be stopped. In this case, damage of a seller losing an opportunity to sell the age restricted product occurs. In addition, the purchaser may be offended, and thus there is a possibility the purchaser will stop using the store. As a result, the seller's loss is further increased.

As means for avoiding such an inconvenience, a means not using an age estimation technique by image analysis is considered.

For example, the means is considered where a sales clerk verifies whether or not a customer attempting to purchase an age restricted product satisfies an age requirement verbally, by verifying with an identity card having the age written thereon, or the like. In addition, a means is considered where a message for inquiring whether or not the customer satisfies the age requirement is displayed on a display directed to the customer and an input corresponding to “satisfied” or “unsatisfied” is received from the customer.

However, in a case of these means, there is a problem that age verification is performed even on a customer who obviously satisfies the age requirement, as with other customers. Some of the customers obviously satisfying the age requirement dislike such age verification.

An object of the invention is to provide a new technique for performing age verification of a customer purchasing an age restricted product.

### Solution to Problem

According to the invention, there is provided a checkout apparatus including a product identification information reception unit that receives an input of identification information of a product, a determination unit that determines whether or not a customer satisfies an age requirement by analyzing an image obtained by photographing the customer when the identification information of an age restricted product is input, and a notification unit that outputs a warning for prompting age verification in a case where the determination unit determines that the customer does not satisfy the age requirement, and does not output the warning in a case where the determination unit determines that the customer satisfies the age requirement.

In addition, according to the invention, there is provided a checkout apparatus including a product identification information reception unit that receives an input of identification information of a product, a determination unit that determines whether or not a customer satisfies an age requirement by analyzing an image obtained by photographing the customer when the identification information of an age restricted product is input, and an output unit that outputs information indicating that the customer satisfies the age requirement, in a case where the determination unit determines that the customer satisfies the age requirement.

In addition, according to the invention, there is provided a checkout method executed by a computer, the method including a product identification information reception step of receiving an input of identification information of a product, a determination step of determining whether or not a customer satisfies an age requirement by analyzing an image obtained by photographing the customer when the identification information of an age restricted product is input, and a notification step of outputting a warning for prompting age verification in a case where it is determined in the determination step that the customer does not satisfy the age requirement, and not outputting the warning in a case where it is determined in the determination step that the customer satisfies the age requirement.

In addition, according to the invention, there is provided a program causing a computer to function as a product identification information reception unit that receives an input of identification information of a product, a determination unit that determines whether or not a customer satisfies an age requirement by analyzing an image obtained by photographing the customer when the identification information of an age restricted product is input, and a notification unit that outputs a warning for prompting age verification in a case where the determination unit determines that the customer does not satisfy the age requirement, and does not output the warning in a case where the determination unit determines that the customer satisfies the age requirement.

In addition, according to the invention, there is provided a checkout method executed by a computer, the method including a product identification information reception step of receiving an input of identification information of a product, a determination step of determining whether or not a customer satisfies an age requirement by analyzing an image obtained by photographing the customer when the identification information of an age restricted product is input, and an output step of outputting information indicating that the customer satisfies the age requirement, in a case where it is determined in the determination step that the customer satisfies the age requirement.

In addition, according to the invention, there is provided a program causing a computer to function as a product identification information reception unit that receives an input of identification information of a product, a determination unit that determines whether or not a customer satisfies an age requirement by analyzing an image obtained by photographing the customer when the identification information of an age restricted product is input, and an output unit that outputs information indicating that the customer satisfies the age requirement, in a case where the determination unit determines that the customer satisfies the age requirement.

### Advantageous Effects of Invention

According to the invention, a new technique for performing age verification of a customer purchasing an age restricted product is realized.

### BRIEF DESCRIPTION OF THE DRAWINGS

The above-described objects, other objects, features and advantages will be further apparent from the preferred exemplary embodiments described below, and the accompanying drawings as follows.

FIG. 1 is a conceptual diagram illustrating an example of a hardware configuration of an apparatus according to the exemplary embodiment.

FIG. 2 is an example of a schematic diagram illustrating an outer appearance of a checkout apparatus according to the exemplary embodiment.

FIG. 3 is an example of a functional block diagram of the checkout apparatus according to the exemplary embodiment.

FIG. 4 is a schematic diagram illustrating an example of information for specifying an age restricted product.

FIG. 5 is a flow chart illustrating an example of a flow of processing of the checkout apparatus according to the exemplary embodiment.

FIG. 6 is an example of a functional block diagram of the checkout apparatus according to the exemplary embodiment.

FIG. 7 is an example of a functional block diagram of the checkout apparatus according to the exemplary embodiment.

FIG. 8 is a flow chart illustrating an example of a flow of processing of the checkout apparatus according to the exemplary embodiment.

FIG. 9 is an example of a functional block diagram of the checkout apparatus according to the exemplary embodiment.

FIG. 10 is an example of a functional block diagram of the checkout apparatus according to the exemplary embodiment.

FIG. 11 is a flow chart illustrating an example of a flow of processing of the checkout apparatus according to the exemplary embodiment.

### DESCRIPTION OF EXEMPLARY EMBODIMENTS

First, an example of a hardware configuration of an apparatus according to the exemplary embodiment will be described. Each unit included in the apparatus according to the exemplary embodiment is constituted by an arbitrary combination of hardware and software on the basis of a central processing unit (CPU), a memory, a program loaded into the memory (including a program which is stored in the memory in advance at the time of shipping and a program which is downloaded from a storage medium such as a compact disc (CD), or a server or the like on the Internet) of an arbitrary computer, a storage unit such as a hard disk which stores the program, and an interface for network connection. In addition, one skilled in the art can understand that various modifications can be made to the examples for realizing the method and apparatus.

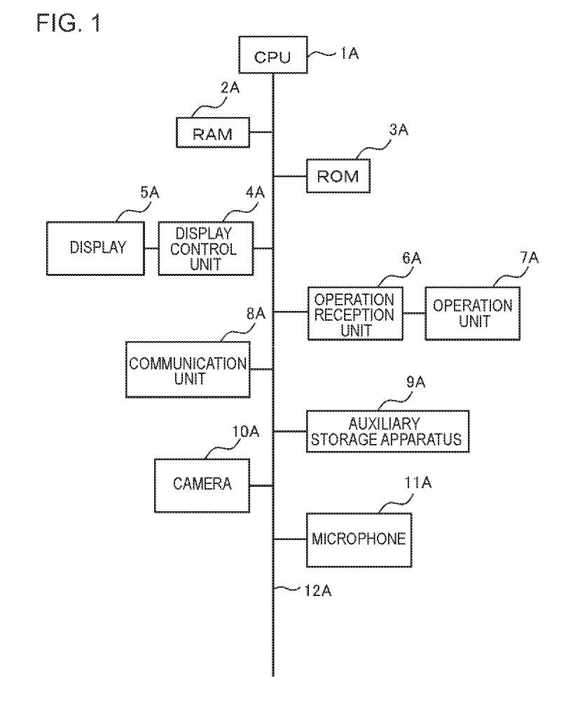

FIG. 1 is a conceptual diagram illustrating an example of a hardware configuration of the apparatus according to the exemplary embodiment. As shown in the drawing, the apparatus according to the exemplary embodiment includes, for example, a CPU 1A, a random access memory (RAM) 2A, a read only memory (ROM) 3A, a display control unit 4A, a display 5A, an operation reception unit 6A, an operation unit 7A, a communication unit 8A, an auxiliary storage device 9A, a camera 10A, a microphone 11A, and the like that are connected to each other by a bus 12A. Note that, although not shown in the drawing, the apparatus may further include other components such as an input and output interface and a speaker which are connected to an external apparatus in a wired manner. In addition, the camera 10A and the microphone 11A may be connected to the bus 12A through the communication unit 8A or the above-mentioned input and output interface instead of being directly connected to the bus 12A.

The CPU 1A controls the overall computer of the apparatus together with each component. The ROM 3A includes an area in which programs for operating the computer, various application programs, various pieces of setting data used during the operation of the programs, and the like are stored. The RAM 2A includes an area, such as a work area for the operation of the programs, which transitorily stores data. The auxiliary storage device 9A is, for example, a hard disc drive (HDD), and can store large-capacity data.

The display 5A is, for example, a display apparatus (a light emitting diode (LED) display, a liquid crystal display, an organic electro luminescence (EL) display, or the like). The display 5A may be a touch panel display integrated with a touch pad. The display control unit 4A reads data stored in a video RAM (VRAM), performs predetermined process on the read data, and transmits the processed data to the display 5A, thereby performing various screen displays. The operation reception unit 6A receives various operations through the operation unit 7A. The operation unit 7A includes an operation key, an operation button, a switch, a jog dial, a touch panel display, a keyboard, a scanner, and the like. The communication unit 8A is connected to a network, such as the Internet or a local area network (LAN), in a wired and/or wireless manner to communicate with other electronic apparatuses.

Hereinafter, the exemplary embodiment will be described. Note that, functional block diagrams used in describing the following exemplary embodiment show function-based blocks rather than hardware-based configurations. In the functional block diagrams, although a description is given such that each apparatus is realized by one equipment, the realization means therefor is not limited thereto. In other words, each apparatus may be configured to be physically or logically separated. Note that the same components will be denoted by the same reference numerals and signs, and a description thereof will not be repeated.

### First Exemplary Embodiment

First, an outline of this exemplary embodiment will be described. The checkout apparatus according to this exemplary embodiment analyzes an image obtained by photographing a customer and determines whether or not an age requirement is satisfied when identification information of an age restricted product is input. In a case where it is determined that the age requirement is not satisfied, the checkout apparatus outputs a warning for prompting age verification. On the other hand, in a case where it is determined that the age requirement is satisfied, the checkout apparatus does not output the warning.

Hereinafter, a configuration of the checkout apparatus according to this exemplary embodiment will be described in detail.

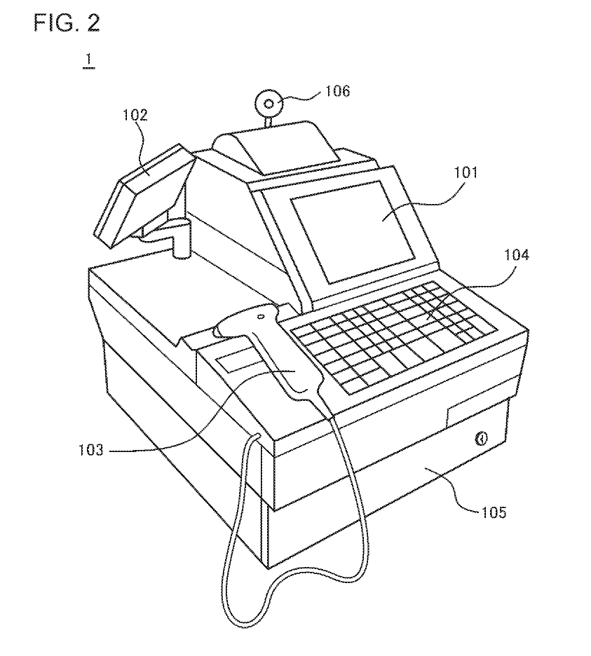

First, FIG. 2 schematically illustrates an example of an outer appearance of a checkout apparatus 1 according to this exemplary embodiment. The checkout apparatus 1 includes a display 101, a display 102 for customers, a scanner 103, input buttons 104, a drawer 105, and a camera 106.

The scanner 103 reads identification information (for example, a one-dimensional code such as a barcode, a two-dimensional code such as a QR code (registered trademark), or the like) which is attached to a product. The input buttons 104 are associated with a predetermined product, a numeral, a predetermined process (for example, a payment process), and the like. An input corresponding thereto is performed by pressing down each of the input buttons 104.

Information corresponding to a product for which an input is made through the scanner 103 or the input button 104, and the like are displayed on the display 101. For example, a product name, a quantity, a price, a tax-included price, a subtotal, and the like of the input product are displayed. In addition, predetermined information (for example, a warning for prompting an operation such as age verification, or the like) for a sales clerk (operator) may be displayed on the display 101.

At least a portion of the information displayed on the display 101 may be displayed on the display 102 for customers. In addition, information (for example, an advertisement, age verification, and the like) for a customer may be displayed on the display 102 for customers.

At least one of the display 101 and the display 102 for customers may be a touch panel display.

Cash, coupons, and the like are kept in the drawer 105. The camera 106 is installed at a position and in a direction in which the face of a customer during checkout, and the like can be captured. Note that the installation position of the camera 106 is not limited to the position illustrated in FIG. 2. For example, the camera can also be installed at another position such as on a ceiling or on a stand on which the checkout apparatus 1 is installed.

Although not shown in the drawing, the checkout apparatus 1 may include a microphone. The microphone is installed at a position where contents of the conversation between a sales clerk operating the checkout apparatus 1 and a customer during checkout can be recorded.

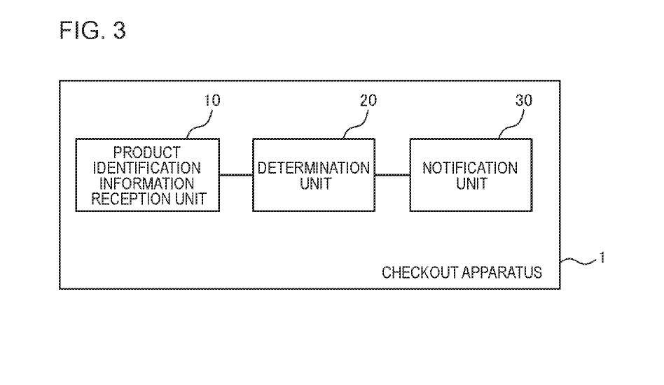

Next, FIG. 3 illustrates an example of a functional block diagram of the checkout apparatus 1 according to this exemplary embodiment. As shown in the drawing, the checkout apparatus 1 includes a product identification information reception unit 10, a determination unit 20, and a notification unit 30.

The product identification information reception unit 10 receives an input of identification information (for example, a product code) of a product. Hereinafter, the identification information of the product will be referred to as product identification information. The product identification information reception unit 10 acquires product identification information which is input through a scanner (see the scanner 103 of FIG. 2), input buttons (see the input buttons 104 of FIG. 2), a touch panel display (see the display 101 of FIG. 2), or the like.

For example, a one-dimensional code such as a barcode or a two-dimensional code such as a QR code (registered trademark) is scanned using the scanner (see the scanner 103 of FIG. 2), and thus product identification information corresponding to the code is input. In addition, for example, the input buttons (see the input buttons 104 of FIG. 2) are pressed down, or buttons displayed on the touch panel display (see the display 101 of FIG. 2) are touched, and thus product identification information corresponding to each button is input.

The determination unit 20 analyzes an image obtained by photographing a customer and determines whether or not an age requirement is satisfied when product identification information of an age restricted product is input. The age requirement is, for example, 18 years or over, 20 years or over, or the like, but is not limited thereto.

The age requirement may be an actual age-requirement (hereinafter, an “actual age-requirement”) itself which is imposed over the purchase of an age restricted product determined by law or the like, or may be different from the actual age-requirement. Specifically, an age requirement used in determination by the determination unit 20 may be stricter. For example, in a case where the actual age-requirement is “20 years or over”, an age requirement used in determination by the determination unit 20 may be “40 years or over” or the like. In addition, in a case where the actual age-requirement is “18 years or over”, an age requirement used in determination by the determination unit 20 may be “35 years or over” or the like. The effect thereof will be described below. Hereinafter, the age requirement used in determination by the determination unit 20 will be referred to as an “age requirement for determination”.

The determination unit 20 performs a process of detecting that product identification information of an age restricted product has been input and a process of analyzing an image obtained by photographing a customer and determining whether or not an age requirement for the determination has been satisfied. In this exemplary embodiment, a means for realizing these processes of the determination unit 20 is not limited, and any method can be adopted. Hereinafter, an example thereof will be described.

First, an example of the process of detecting that product identification information of an age restricted product has been input will be described.

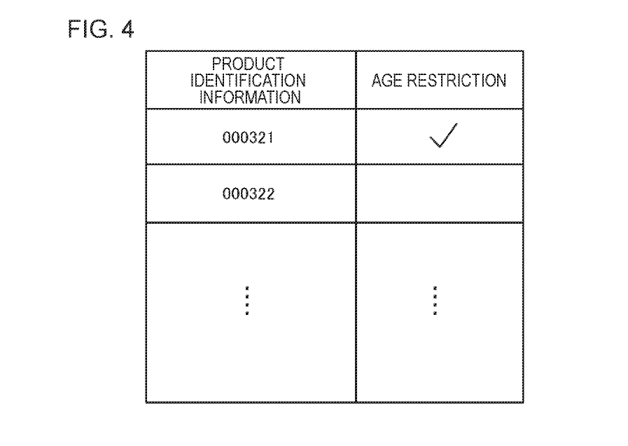

Information for specifying an age restricted product is stored in advance in a storage device of the checkout apparatus 1 or a storage device of an external apparatus communicable with the checkout apparatus 1. For example, as illustrated in FIG. 4, the information may be information in which information indicating whether or not a product corresponds to an age restricted product is attached to each piece of product identification information. In a case of the example of FIG. 4, a product for which a flag (check mark in the drawing) is set in the column of an age restriction corresponds to an age restricted product. On the other hand, a product for which a flag (check mark in the drawing) is not set in the column of the age restriction does not correspond to an age restricted product.

When the product identification information reception unit 10 receives an input of product identification information, the determination unit 20 may determine whether or not a product identified from the product identification information corresponds to an age restricted product in each case, on the basis of the product identification information and information for specifying the above-described age restricted product. In this manner, the determination unit 20 may detect that identification information of the age restricted product has been input.

Next, a description will be given of an example of the process for analyzing an image obtained by photographing a customer and determining whether or not an age requirement for determination is satisfied.

A feature value (for example, a positional relation, a contour, a wrinkle, and the like of a face part such as an eye, the nose, the mouth, or the like) such as the face and age information of each of a plurality of persons are stored in association with each other in the storage device of the checkout apparatus 1 or the storage device of the external apparatus communicable with the checkout apparatus 1. The age information may be the age itself, may be a value indicating whether or not an age requirement for determination is satisfied, or may be an age group (one's teens, one's twenties, one's thirties, or the like).

When the determination unit 20 acquires an image obtained by photographing a customer, the determination unit analyzes the image in accordance with a predetermined algorithm and extracts predetermined feature values (for example, a positional relation, a contour, a wrinkle, and the like of a face part such as an eye, the nose, the mouth, or the like).

Thereafter, the determination unit 20 obtains age information (for example, an age, an age group, and a value indicating whether or not an age requirement for determination is satisfied, and the like) of a customer by inputting a feature value extracted from the image of the customer to a learning result (for example, a function) which is obtained by any machine learning based on training data constituted by the feature values (explanatory variable) and the age information (objective variable) which are stored in the storage device.

As another example, the determination unit 20 may identify a feature value which approximates to the feature value extracted from the image of the customer, among the feature values stored in the storage device, at a predetermined level or higher. The determination unit 20 may acquire age information (for example, an age, an age group, and a value indicating whether or not an age requirement for determination is satisfied, or the like) which is associated with the identified feature value, as the customer's age information.

In a case where the age or the age group of the customer is obtained as the age information, the determination unit 20 determines whether or not the customer satisfies the age requirement for determination by determining whether or not the obtained age or age group satisfies the age requirement for determination (for example, 18 years or over, 20 years or over, 35 years or over, 40 years or over, or the like). In a case where a value indicating whether or not the age requirement for determination is satisfied is obtained as the age information, the determination unit 20 sets the value to be a result of determination regarding whether or not the customer satisfies the age requirement for determination. In this manner, the determination unit 20 may determine whether or not the customer satisfies the age requirement for determination. The determination unit 20 outputs the obtained determination result (“the customer satisfies the age requirement for determination” or “the customer does not satisfy the age requirement for determination”) toward the notification unit 30.

The process performed by the determination unit 20 which is described here is just an example, and the determination unit 20 may perform a process of detecting that identification information of an age restricted product has been input and a process of analyzing an image obtained by photographing a customer and determining whether or not an age requirement for determination has been satisfied, by using another method.

As described above, the age requirement for determination may be different from an actual age-requirement. Specifically, the age requirement for determination may be stricter. For example, in a case where the actual age-requirement is “M years or over”, the age requirement for determination may be “M+α years or over” (M and α are integers of 1 or greater).

In a case where the age requirement for determination is determined in this manner, the determination unit 20 outputs a result that “an age requirement for determination is satisfied” in a case where a result of age estimation by image analysis exceeds a lower limit (M years) of an actual age-requirement by α years or over, that is, a case where the result of the age estimation by image analysis obviously satisfies the actual age-requirement.

The determination unit 20 outputs a result that “the age requirement for determination is not satisfied” in a case where the result of the age estimation, by image analysis, falls below the lower limit (M years) of the actual age-requirement, and a case where the result of the age estimation by image analysis exceeds the lower limit (M years) of the actual age-requirement but the excess over the lower limit is less than α years, that is, a case where it cannot be said that the result of the age estimation by image analysis obviously satisfies the actual age-requirement.

Here, α may be determined on the basis of an error of the age estimation by image analysis. For example, the error itself of the age estimation by image analysis which is calculated by a predetermined method may be set to α, or a value obtained by correcting the calculated error by any method may be set to α.

In this manner, the determination unit 20 outputs the result that “an age requirement for determination is satisfied” in a case where the result of the age estimation by image analysis satisfies the actual age-requirement even when an error of the age estimation by image analysis is considered.

The determination unit 20 outputs the result that “the age requirement for determination is not satisfied” in a case where the result of the age estimation by image analysis does not satisfy the actual age-requirement and a case where a result of determination regarding whether or not the actual age-requirement is satisfied may vary when an error of the age estimation by image analysis is considered.

The notification unit 30 outputs a warning for prompting age verification in a case where the determination unit 20 determines that the age requirement for determination is not satisfied. The warning for prompting age verification is output toward a sales clerk and/or a customer. On the other hand, the notification unit 30 does not output a warning for prompting age verification in a case where the determination unit 20 determines that the age requirement for determination is satisfied.

There are various modes of warning for prompting age verification. For example, a message (for example, ‘Please verify whether the customer satisfies the age requirement’) for promoting age verification may be displayed on a display (see the display 101 of FIG. 2) which is directed to a sales clerk. In addition, a warning lamp provided at a position where the sales clerk can view the warning lamp may be turned on, blinking or the like. In addition, a message for promoting age verification may be output as voice through a speaker. In addition, a message (for example, ‘Is the age requirement satisfied?’) for promoting age verification may be displayed on a display (see the display 102 for customers of FIG. 2) which is directed to a customer. Thereafter, the checkout apparatus 1 may receive an input of a response regarding whether or not an actual age-requirement is satisfied, from the customer.

In a case where the warning is output toward the sales clerk, the notification unit 30 may output at least one of the date of birth satisfying the actual age-requirement and the date of birth not satisfying the actual age-requirement, in addition to the warning. For example, a message such as “a person born on or after the DD (day) of MM (month) of YY (year) can purchase this product” or “a person born before the DD (day) of MM (month) of YY (year) cannot purchase this product” may be output through a display or a speaker.

A method for a sales clerk to perform age verification on a customer, a method of asking the customer's date of birth is considered. However, it is not easy to immediately calculate a person's age from the date of birth. When such information is provided toward the sales clerk together with a warning, the sales clerk can easily determine whether or not an actual age-requirement is satisfied, from the customer's date of birth.

When an age requirement for determination is set to be stricter than the actual age-requirement, the notification unit 30 outputs the warning in a case where a result of age estimation by image analysis does not satisfy the actual age-requirement, a case where the result of the age estimation by image analysis exceeds a lower limit of the actual age-requirement but the excess over the lower limit is small, and the like. In a case where the result of the age estimation by image analysis greatly exceeds the lower limit of the actual age-requirement, the notification unit 30 does not output the warning.

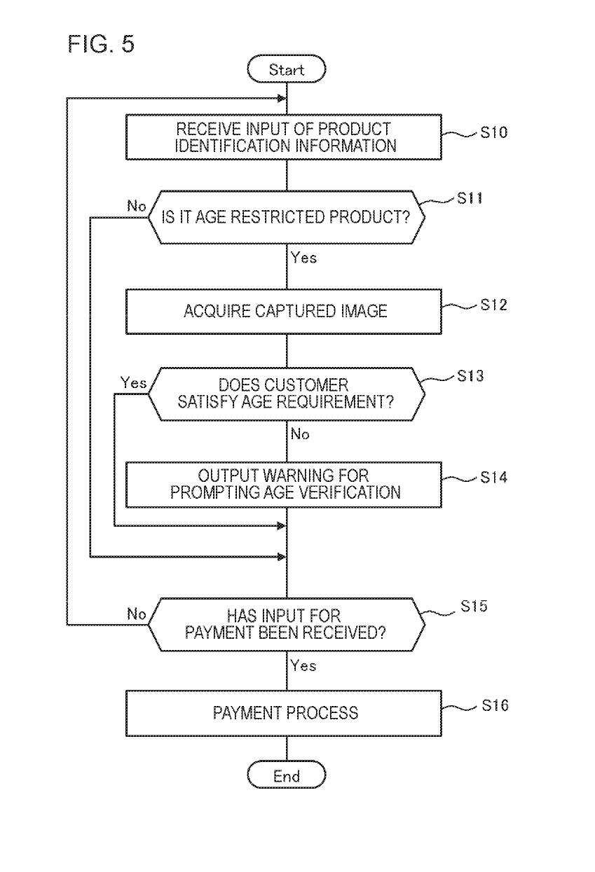

Next, an example of a flow of processing of the checkout apparatus 1 according to this exemplary embodiment will be described with reference to a flow chart of FIG. 5.

First, when the product identification information reception unit 10 receives an input of product identification information (S10), the determination unit 20 determines whether or not the information corresponds to product identification information of an age restricted product. In a case of not corresponding to an age restricted product (No of S11), the processing proceeds to S15.

In S15, the checkout apparatus 1 determines whether or not an input for payment has been received. The input for payment is an input for closing the reception of the input of the product identification information and then starting a payment process. The input for payment may be an input of a deposit amount, or may be another input. When the input for payment has been received (Yes in S15), the checkout apparatus 1 proceeds to the payment process (S16). Although details of the payment process are not particularly limited, the payment process may be, for example, the calculation of the amount of change, the display of a calculation result (change), the output of change, the opening of a drawer, or the like.

On the other hand, in a case where the input for payment has not been received (No in S15), the processing may return to S10 to receive the input of the product identification information.

In a case where a product identification information which has been input in S10 corresponds to a product identification information of the age restricted product (Yes in S11), the determination unit 20 acquires an image obtained by photographing a customer's face or the like (for example, an image captured by the camera 106 of FIG. 2) (S12). The determination unit 20 analyzes the acquired image and determines whether or not the customer satisfies an age requirement for determination.

In a case where it is determined that the customer does not satisfy the age requirement for determination (No in S13), the notification unit 30 outputs a warning for prompting age verification (S14). Thereafter, the processing proceeds to S15. On the other hand, in a case where it is determined that the customer satisfies the age requirement for determination (Yes in S13), the processing proceeds to S15. That is, in this case, the warning for prompting age verification is not output.

According to the above-described checkout apparatus 1 of this exemplary embodiment, a new technique for performing age verification of a customer purchasing an age restricted product is realized.

When product identification information of an age restricted product is input, the checkout apparatus 1 analyzes the customer's face image and the like and determines whether or not the customer satisfies an age requirement for determination. In a case where it is determined that the customer does not satisfy the age requirement for determination, a warning for prompting age verification is output. On the other hand, in a case where it is determined that the customer satisfies the age requirement for determination, the warning is not output. According to the checkout apparatus 1, a sales clerk or the like may perform age verification only in a case where the checkout apparatus 1 determines that the customer does not satisfy the age requirement for determination.

As a result, it is possible to reduce troublesome interaction of the sales clerk in verifying whether an age requirement is satisfied verbally or by verifying with an identity card having the age written thereon, or the like with respect to all customers attempting to purchase an age restricted product.

In addition, it is possible to reduce troublesome interaction of displaying a message for inquiring whether or not the age requirement is satisfied toward all of the customers attempting to purchase an age restricted product, and receiving input corresponding to “satisfied” or “unsatisfied” from the customer.

In addition, when an age requirement for determination is set to be stricter than an actual age-requirement, the notification unit 30 outputs the warning described above in a case where a result of age estimation by image analysis does not satisfy the actual age-requirement, a case where the result of the age estimation by image analysis exceeds a lower limit of the actual age-requirement but the excess over the lower limit is small, and the like. In a case where the result of the age estimation by image analysis exceeds the lower limit of the actual age-requirement but the excess over the lower limit is small, a result regarding whether or not the actual age-requirement is satisfied may vary due to an estimation error and the like. In a case of this exemplary embodiment, it is also possible to output a warning for prompting age verification in such a case.

In a case where the result of the age estimation by image analysis greatly exceeds the lower limit of the actual age-requirement, the notification unit 30 does not output the warning.

According to this exemplary embodiment, it is possible to reduce troublesomeness of evenly performing an age verification operation on all customers and perform age verification only on a customer who actually requires an age verification. As a result, a reduction in the burden of work on a sales clerk and a reduction in the burden of a response on a customer are realized.

### Second Exemplary Embodiment

A checkout apparatus 1 according to this exemplary embodiment is different from that in the first exemplary embodiment in that the checkout apparatus outputs a warning for prompting age verification and then receives a predetermined input for the warning from a user. The other configurations are the same as those in the first exemplary embodiment.

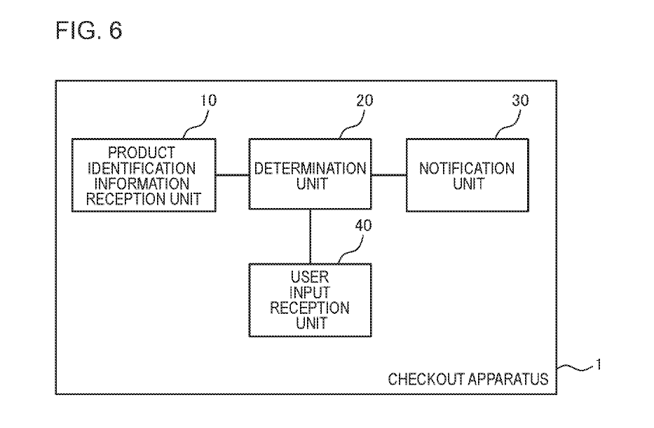

FIG. 6 illustrates an example of a functional block diagram of the checkout apparatus 1 according to this exemplary embodiment. As shown in the drawing, the checkout apparatus 1 includes a product identification information reception unit 10, a determination unit 20, a notification unit 30, and a user input reception unit 40. Configurations of the product identification information reception unit 10, the determination unit 20, and the notification unit 30 are the same as those in the first exemplary embodiment.

In a case where the determination unit 20 determines that an age requirement for determination is not satisfied, the user input reception unit 40 thereafter performs a verification process of receiving an input to the effect that a customer satisfies an actual age-requirement or an input to the effect that the customer does not satisfy the actual age-requirement. Note that, in a case where the notification unit 30 does not output the warning described above, the user input reception unit 40 does not perform the verification process.

For example, the user input reception unit 40 may receive the input to the effect that the customer satisfies the actual age-requirement or the input to the effect that the customer does not satisfy the actual age-requirement from a sales clerk (user) through input buttons (see the input buttons 104 of FIG. 2) or a touch panel display (see the display 101 of FIG. 2).

In addition, the user input reception unit 40 may receive the input to the effect that the customer satisfies the actual age-requirement or the input to the effect that the customer does not satisfy the actual age-requirement from a customer (user) through a touch panel display (see the display 102 for customers of FIG. 2).

In addition, in a case where the notification unit 30 outputs the warning, the user input reception unit 40 may thereafter perform a verification process of receiving an input to the effect that age verification has been performed on a customer from a user, instead of the above-mentioned verification process. Also in this case, in a case where the notification unit 30 does not output the warning, the user input reception unit 40 does not perform a verification process.

For example, the user input reception unit 40 may receive an input to the effect that age verification has been performed on a customer from a sales clerk (user), through input buttons (see the input buttons 104 of FIG. 2) or a touch panel display (see the display 101 of FIG. 2).

It should be noted that, when the user input reception unit 40 performs any of the above-mentioned verification processes and receives the above-mentioned input, information indicating contents of the input may be stored in a storage device within the checkout apparatus 1 or a storage device within an external apparatus configured to communicate with the checkout apparatus 1 in association with the contents (for example, purchased products, a total amount, information for identifying a sales clerk, the date of purchase, and the like) of a checkout process for the customer.

According to the above-described checkout apparatus 1 of this exemplary embodiment, it is possible to realize the same advantageous effects as those in the first exemplary embodiment.

In addition, after a warning for prompting age verification is output, it is possible to receive a predetermined input for the warning from a user. It is possible to reduce an inconvenience of a warning being eluded, in combination with a process of receiving the predetermined input after the warning is output.

In addition, according to the checkout apparatus 1 of this exemplary embodiment allowing contents of an input received by the user input reception unit 40 to be stored in association with contents of a checkout process for each customer, a manager or the like can verify the contents of an age verification operation with reference to the data.

### Third Exemplary Embodiment

A checkout apparatus 1 according to this exemplary embodiment is different from those in the first and second exemplary embodiments in that a checkout process is stopped until a user input reception unit 40 receives a predetermined input in a case where a determination unit 20 determines that an age requirement for determination is not satisfied. The other configurations are the same as those in the first and second exemplary embodiments.

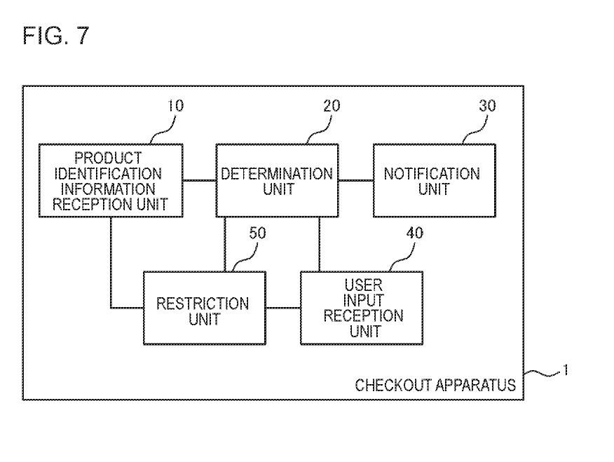

FIG. 7 illustrates an example of a functional block diagram of the checkout apparatus 1 according to this exemplary embodiment. As illustrated in the drawing, the checkout apparatus 1 includes a product identification information reception unit 10, a determination unit 20, a notification unit 30, a user input reception unit 40, and a restriction unit 50. Configurations of the product identification information reception unit 10, the determination unit 20, the notification unit 30, and the user input reception unit 40 are the same as those in the first and second exemplary embodiments.

The restriction unit 50 stops a checkout process until the user input reception unit 40 receives the input in a case where the determination unit 20 determines that an age requirement for determination is not satisfied. The input is an input to the effect that a customer satisfies an actual age-requirement, an input to the effect that the customer does not satisfy the actual age-requirement, or an input to the effect that age verification has been performed on the customer.

As a means for stopping the checkout process, the restriction unit 50 may control, for example, the product identification information reception unit 10. That is, the restriction unit 50 may control the product identification information reception unit 10 so as not to receive an input of new product identification information while the checkout process is stopped. It should be noted that the restriction unit 50 may control the product identification information reception unit so as not to receive other inputs (for example, an input of a deposit amount, and the like) regarding the checkout process while the checkout process is stopped.

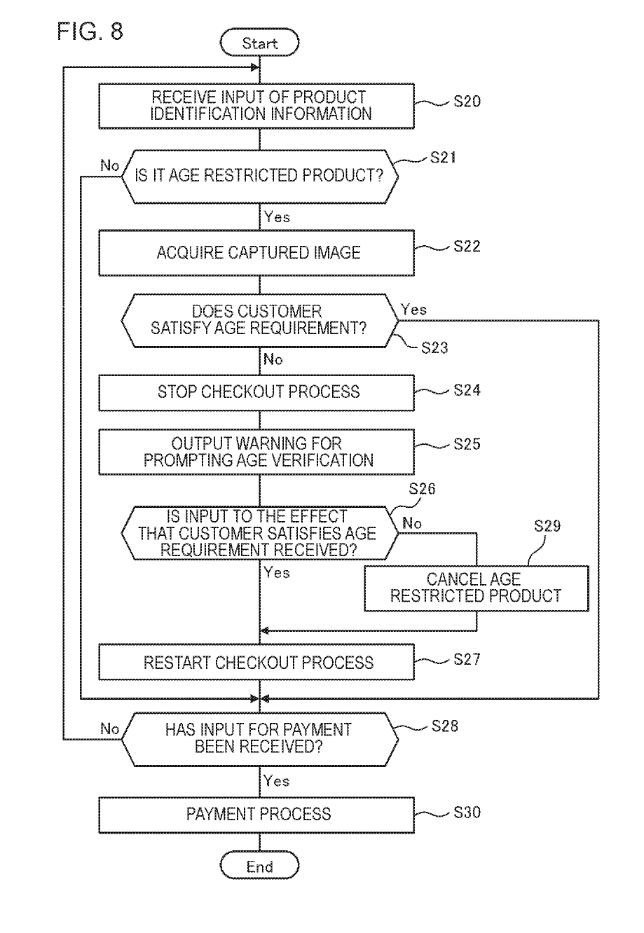

Next, an example of a flow of processing performed by the checkout apparatus 1 according to this exemplary embodiment will be described with reference to a flow chart in FIG. 8.

First, when the product identification information reception unit 10 receives an input of product identification information (S20), the determination unit 20 determines whether or not the information corresponds to product identification information of an age restricted product. In a case of not corresponding to an age restricted product (No in S21), the processing proceeds to S28.

In S28, it is determined whether or not an input for payment has been received. In a case where the input for payment has been received (Yes in S28), the processing proceeds to a payment process (S30). On the other hand, in a case where the input for payment has not been received (No in S28), the processing returns to S20, and thus it is possible to receive an input of product identification information.

In a case where the product identification information which is input in S20 corresponds to product identification information of an age restricted product (Yes in S21), the determination unit 20 acquires an image obtained by photographing a customer's face or the like (for example, an image captured by the camera 106 of FIG. 2). The determination unit 20 analyzes the acquired image and determines whether or not the customer satisfies an age requirement for determination.

In a case where it is determined that the customer does not satisfy the age requirement for determination (No in S23), the restriction unit 50 performs a control so as to stop the checkout process (S24). In addition, the notification unit 30 outputs a warning for prompting age verification (S25).

Thereafter, when the user input reception unit 40 receives an input to the effect that the customer satisfies the age requirement (Yes in S26), the restriction unit 50 performs a control so as to restart the checkout process (S27). Thereafter, the processing proceeds to S28.

On the other hand, when the user input reception unit 40 receives an input to the effect that the customer does not satisfy the age requirement after the warning for prompting age verification is output in S25 (No in S26), the restriction unit 50 cancels the input age restricted product from a target for checkout (S29). The restriction unit 50 performs a control so as to restart the checkout process (S27). Thereafter, the processing proceeds to S28.

Note that, in a case where the determination unit 20 determines that the customer satisfies the age requirement for determination (Yes in S23), the processing proceeds to S28. That is, in this case, the output of a warning by the notification unit 30, the control of the stop and restart of a checkout process by the restriction unit 50, and the reception of an input by the user input reception unit 40 are not performed.

According to this exemplary embodiment described above, it is possible to realize the same advantageous effects as those in the first and second exemplary embodiments.

In addition, in a case of this exemplary embodiment, it is possible to stop a checkout process until a predetermined input for a warning for prompting age verification is received from a user (for example, a sales clerk or a customer) in a case where the warning is output. According to this exemplary embodiment, it is possible to reduce an inconvenience that a warning for prompting age verification is neglected, and a checkout process is performed as it is. In addition, it is possible to reliably make a user (for example, a sales clerk or a customer) recognize the presence of the warning.

### Fourth Exemplary Embodiment

A checkout apparatus 1 according to this exemplary embodiment is different from those in the first to third exemplary embodiments in that voice recording of the contents of a sales clerk speaking starts in a case where a notification unit 30 outputs a warning for prompting age verification toward the sales clerk. The other configurations are the same as those in the first to third exemplary embodiments.

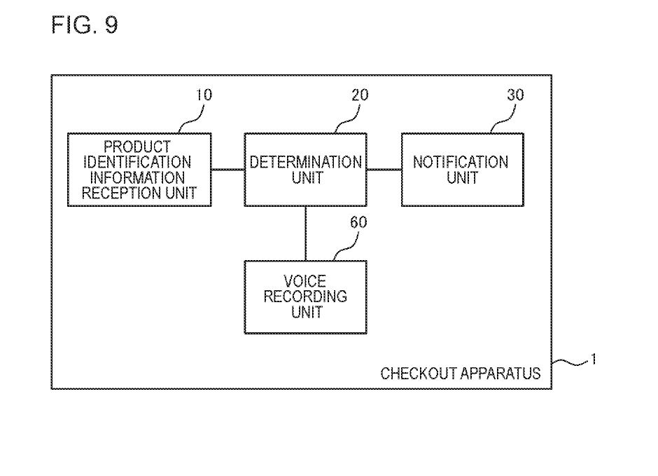

FIG. 9 illustrates an example of a functional block diagram of the checkout apparatus 1 according to this exemplary embodiment. As illustrated in the drawing, the checkout apparatus 1 includes a product identification information reception unit 10, a determination unit 20, a notification unit 30, and a voice recording unit 60. It should be noted that the checkout apparatus 1 may include at least one of a user input reception unit 40 and a restriction unit 50. Configurations of the product identification information reception unit 10, the determination unit 20, the notification unit 30, the user input reception unit 40, and the restriction unit 50 are the same as those in the first to third exemplary embodiments.

The voice recording unit 60 starts to record voice in a case where the determination unit 20 determines that an age requirement for determination is not satisfied. For example, the voice recording unit 60 may start the voice recording in response to the output of the above-mentioned warning. The voice recording unit 60 receives an input of voice data through a microphone installed at a position where the contents of speech of an operator (sales clerk) of the checkout apparatus 1 can be collected. The voice recording unit 60 accumulates the voice data.

The voice data accumulated by the voice recording unit 60 may be stored in a storage device within the checkout apparatus 1 or a storage device within an external apparatus configured to communicate with the checkout apparatus 1 in association with the contents (for example, purchased products, a total amount, information for identifying a sales clerk, the date of purchase, and the like) of a checkout process for a customer.

According to this exemplary embodiment described above, it is possible to realize the same advantageous effects as those in the first to third exemplary embodiments. In addition, voice data accumulated by the voice recording unit 60 is checked, and thus it is possible to ascertain whether or not a sales clerk has performed age verification on a customer verbally.

### Fifth Exemplary Embodiment

A checkout apparatus 1 according to this exemplary embodiment is different from those in the first to fourth exemplary embodiments in the determination method of a determination unit 20 regarding whether or not an age requirement for determination is satisfied. The other configurations are the same as those in the first to fourth exemplary embodiments.

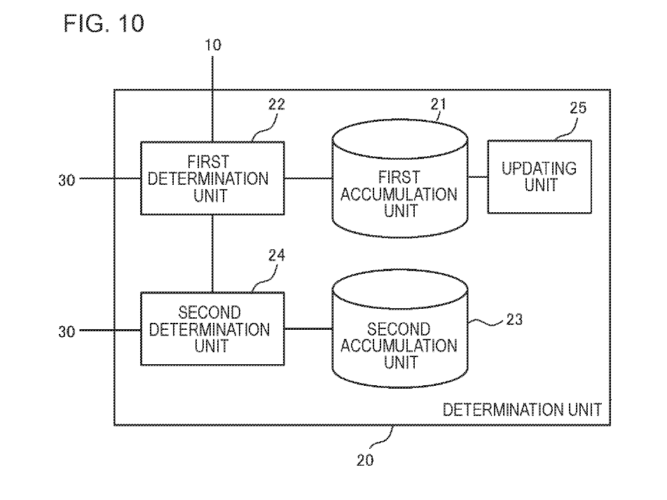

FIG. 10 schematically illustrates an example of a functional block diagram of the determination unit 20 according to this exemplary embodiment. As shown in the drawing, the determination unit 20 includes a first accumulation unit 21, a first determination unit 22, a second accumulation unit 23, a second determination unit 24, and an updating unit 25.

The first accumulation unit 21 accumulates a feature value (a feature value of a face image and the like) of each customer who has visited the store in the past and purchased an age restricted product.

It should be noted that the latest visit date of each customer is associated with each feature value.

When identification information of the age restricted product is input, the first determination unit 22 determines whether or not the customer is a customer who has visited the store in the past and purchased an age restricted product, on the basis of an image obtained by photographing the customer and the feature values accumulated in the first accumulation unit 21.

For example, the first determination unit 22 collates a feature value extracted from the image obtained by photographing the customer with the feature values accumulated in the first accumulation unit 21, and determines whether or not a feature value matching the feature value extracted from the image obtained by photographing the customer is retained in the first accumulation unit 21.

In a case where a matching feature value is retained, the first determination unit 22 determines that the customer is a customer who has visited the store in the past and purchased an age restricted product. The first determination unit 22 determines that the customer satisfies an age requirement for determination. In this case, a warning of the notification unit 30 is not output.

On the other hand, in a case where there is no matching feature value retained, the first determination unit 22 does not determine that the customer is a customer who has visited the store in the past and purchased an age restricted product.

The second accumulation unit 23 accumulates a feature value (for example, a feature value of a face and the like) of a person and the age information in association with each other. The age information may be the age itself as described in the first exemplary embodiment, may be a value indicating whether or not an age requirement for determination is satisfied, or may be an age group (one's teens, one's twenties, one's thirties, or the like).

In a case where the first determination unit 22 does not determine that the customer is a customer who has visited the store in the past and purchased an age restricted product, the second determination unit 24 determines whether or not the customer satisfies an age requirement for determination, on the basis of an image obtained by photographing the customer and the feature values accumulated in the second accumulation unit 23. The determination process of the second determination unit 24 is the same as the process of the determination unit 20 described in the first exemplary embodiment, and thus a description thereof will not be repeated here.

The updating unit 25 manages information accumulated in the first accumulation unit 21. For example, the updating unit 25 may acquire a feature value of a face image and the like of a customer having purchased an age restricted product, and may determine whether or not a feature value similar to the feature value at a predetermined level or higher has been already retained in the first accumulation unit 21. In a case where a feature value similar to the feature value is not retained in the first accumulation unit, the updating unit 25 may newly register the feature value in the first accumulation unit 21 in association with the date of the day (the latest visit date). On the other hand, in a case where a feature value similar to the feature value is retained in the first accumulation unit, the updating unit 25 may update the latest visit date associated with the feature value to the date of the day.

In addition, the updating unit 25 may eliminate a feature value in which the number of days since the latest visit date up until a certain day exceeds a predetermined value, from the first accumulation unit 21. That is, the updating unit 25 may eliminate a feature value of a customer who has not visited the store for the most recent predetermined period of time, from the first accumulation unit 21.

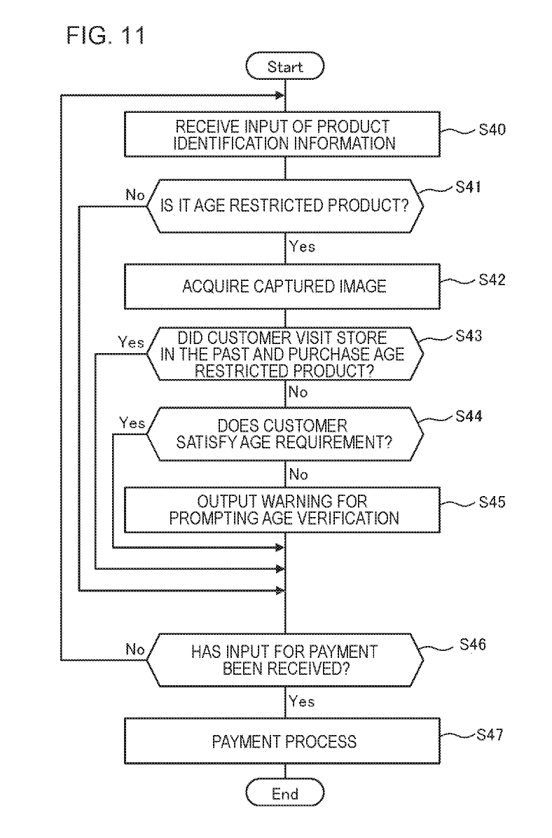

Next, an example of a flow of processing of the checkout apparatus 1 according to this exemplary embodiment will be described with reference to a flow chart in FIG. 11.

First, when the product identification information reception unit 10 receives an input of product identification information (S40), the determination unit 20 determines whether or not the information corresponds to product identification information of an age restricted product. In a case of not corresponding to the age restricted product (No in S41), the processing proceeds to S46.

In S46, it is determined whether or not an input for payment has been received. In a case where the input for payment has been received (Yes in S46), the processing proceeds to a payment process (S47). On the other hand, in a case where the input for payment has not been received (No in S46), the processing returns to S40, and thus it becomes possible to receive an input of product identification information.

In a case where the product identification information which is input in S40 corresponds to product identification information of an age restricted product (Yes in S41), the determination unit 20 acquires an image obtained by photographing a customer's face or the like (for example, an image captured by the camera 106 of FIG. 2). The first determination unit 22 analyzes the acquired image and determines whether or not the customer has visited the store in the past and purchased an age restricted product.

In a case where it is determined that the customer has visited the store in the past and purchased an age restricted product (Yes in S43), the processing proceeds to S46. On the other hand, in a case where it is not determined that the customer has visited the store in the past and purchased an age restricted product (No in S43), the processing proceeds to S44.

In S44, the second determination unit 24 analyzes the image obtained by photographing the customer's face or the like and determines whether or not the customer satisfies an age requirement for determination. In a case where it is determined that the customer satisfies the age requirement for determination (Yes in S44), the processing proceeds to S46. On the other hand, in a case where it is determined that the customer does not satisfy the age requirement for determination (No in S44), the notification unit 30 outputs a warning for prompting age verification (S45). Thereafter, the processing proceeds to S46.

It should be noted that, as a modification example, the control of the stop and restart of a checkout process of the restriction unit 50 and the reception of an input by the user input reception unit 40 may be performed, similar to FIG. 8.

According to this exemplary embodiment described above, it is possible to realize the same advantageous effects as those in the first to fourth exemplary embodiments.

In addition, in a case of this exemplary embodiment, a matching process of identifying the same person is performed before it is determined whether or not an age requirement for determination is satisfied on the basis of a result of an age estimation by image analysis, and it is determined whether or not the age requirement for determination is satisfied on the basis of the matching result. That is, it is determined whether or not the customer matches any of customers who has visited a store in the past and purchased an age restricted product. In a case of matching, it is determined that the customer satisfies the age requirement for determination. In a case where the accuracy of identification of the same person is higher than the accuracy of age estimation, it is possible to increase the accuracy regarding whether or not the customer satisfies the age requirement for determination, with such a configuration.

In addition, in a case of a store, such as a convenience store or a supermarket, which is frequently used in daily life, there is a high possibility that a regular customer repeatedly visits the store within a predetermined period of time. A feature value of a customer who has visited the store within the most recent predetermined period of time and purchased an age restricted product is accumulated in the first accumulation unit 21 by using such a characteristic, and thus it is possible to increase a proportion in which the first determination unit 22 determines that the customer is a customer who has visited the store in the past and purchased an age restricted product. That is, it is possible to reduce the proportion proceeding to a determination process in the second determination unit 24.

In addition, there is a high possibility that a customer who has visited the store in the past but has not visited the store within the most recent predetermined period of time does not visit the store even after that. According to this exemplary embodiment in which such a feature value of a customer is eliminated, it is possible to eliminate unnecessary data from the first accumulation unit 21 and leave only useful data. In this case, the amount of data of an object to be processed by the first determination unit 22 can be reduced, and thus it is possible to reduce the burden of processing of the first determination unit 22.

### Sixth Exemplary Embodiment

This exemplary embodiment is different from the first to fifth exemplary embodiments in the configuration of a notification unit 30. In a case where a determination unit 20 determines that an age requirement for determination is satisfied, the notification unit 30 according to this exemplary embodiment outputs information to that effect (hereinafter, referred to as a “condition conformity notification”).

There are various condition conformity notifications. For example, a message to that effect (for example, a customer satisfies an age requirement) may be displayed on a display (see the display 101 of FIG. 2) which is directed to a sales clerk. In addition, an output lamp provided at a position where the sales clerk can view the output lamp may be turned on or turned off. In addition, a message to that effect may be output as voice through a speaker.

Note that the notification unit 30 may give the above-mentioned warning or may not give the above-mentioned warning in a case where the determination unit 20 determines that an age requirement for determination is not satisfied.

In a case where the notification unit 30 outputs both the above-mentioned warning and the above-mentioned condition conformity notification, a sales clerk can recognize whether or not a customer satisfies an age requirement for determination, by verifying the output pieces of information. On the other hand, in a case where the notification unit 30 outputs only the warning, the sales clerk can recognize that the customer does not satisfy the age requirement for determination in a case where the warning is output, and that the customer satisfies the age requirement for determination in a case where the warning is not output. Further, in a case where the notification unit 30 outputs only the condition conformity notification, the sales clerk can recognize that the customer satisfies the age requirement for determination in a case where the condition conformity notification is output, and that the customer does not satisfy the age requirement for determination in a case where the condition conformity notification is not output.

In addition, in a case where only the condition conformity notification is output, the notification unit 30 can output at least one of the date of birth satisfying the age requirement and the date of birth not satisfying the age requirement, together with the condition conformity notification.

### Modification Example

In the first to sixth exemplary embodiments, the checkout apparatus 1 (for example, a point of sale (POS) register) as illustrated in FIG. 2, that is, the checkout apparatus 1 assuming the operation of a sales clerk has been described as an example. However, the checkout apparatus 1 maybe a so-called self POS register which is operated by a customer. Even the self POS register can be configured in the same manner as in the first to fifth exemplary embodiments, and thus it is possible to realize the same advantageous effects.

Hereinafter, an example of a reference configuration will be appended.

1. A checkout apparatus including:

a product identification information reception unit that receives an input of identification information of a product;

a determination unit that determines whether or not a customer satisfies an age requirement by analyzing an image obtained by photographing the customer when the identification information of an age restricted product is input; and

a notification unit that outputs a warning for prompting age verification in a case where the determination unit determines that the customer does not satisfy the age requirement.

2. The checkout apparatus according to 1, further including:

a user input reception unit that performs, in a case where the determination unit determines that the customer does not satisfy the age requirement, a verification process of receiving an input to the effect that the customer satisfies the age requirement or an input to the effect that the customer does not satisfy the age requirement from a user.

3. The checkout apparatus according to 1, further including:

a user input reception unit that performs a verification process of receiving an input to the effect that age verification has been performed on the customer from a user, in a case where the determination unit determines that the customer does not satisfy the age requirement.

4. The checkout apparatus according to 2 or 3, further including:

a restriction unit that stops a checkout process until the user input reception unit receives the input, in a case where the determination unit determines that the customer does not satisfy the age requirement.

5. The checkout apparatus according to any one of 1 to 4,

wherein the notification unit outputs at least one of a date of birth satisfying the age requirement and a date of birth not satisfying the age requirement, in addition to the warning.

6. The checkout apparatus according to any one of 1 to 5, further including:

a voice recording unit that starts to record voice in a case where the determination unit determines that the customer does not satisfy the age requirement.

7. The checkout apparatus according to any one of 1 to 6,

wherein the determination unit includes

a first accumulation unit that accumulates a feature value of each customer who has visited a store in the past and purchased the age restricted product, and

a first determination unit that determines, when the identification information of the age restricted product is input, whether or not a customer has visited the store in the past and purchased the age restricted product on the basis of the image obtained by photographing the customer and the feature value accumulated in the first accumulation unit, and determines that the customer satisfies the age requirement in a case where the first determination unit determines that the customer has visited the store in the past and purchased the age restricted product.

8. The checkout apparatus according to 7,

wherein the determination unit includes

a second accumulation unit that accumulates a feature value and age information of a person in association with each other, and

a second determination unit that determines whether or not a customer satisfies the age requirement on the basis of the image obtained by photographing the customer and the feature value accumulated in the second accumulation unit, in a case where the first determination unit does not determine that the customer has visited the store in the past and purchased the age restricted product.

9. The checkout apparatus according to 7 or 8,

wherein the first accumulation unit accumulates the feature value in association with a latest visit date of each customer, and

wherein the checkout apparatus further includes an updating unit that eliminates the feature value in which the number of days since the latest visit date up until a certain day exceeds a predetermined value, from the first accumulation unit.

10. A checkout apparatus including:

a product identification information reception unit that receives an input of identification information of a product;

a determination unit that determines whether or not a customer satisfies an age requirement by analyzing an image obtained by photographing the customer when the identification information of an age restricted product is input; and

a notification unit that outputs information indicating that the customer satisfies the age requirement, in a case where the determination unit determines that the customer satisfies the age requirement.

10-2. The checkout apparatus according to 10, further including:

a user input reception unit that performs, in a case where the determination unit determines that the customer does not satisfy the age requirement, a verification process of receiving an input to the effect that the customer satisfies the age requirement or an input to the effect that the customer does not satisfy the age requirement from a user.

10-3. The checkout apparatus according to 10, further including:

a user input reception unit that performs a verification process of receiving an input to the effect that age verification has been performed on the customer from a user, in a case where the determination unit determines that the customer does not satisfy the age requirement.

10-4. The checkout apparatus according to 10-2 or 10-3, further including:

a restriction unit that stops a checkout process until the user input reception unit receives the input, in a case where the determination unit determines that the customer does not satisfy the age requirement.

10-5. The checkout apparatus according to any one of 10 to 10-4,

wherein the notification unit outputs at least one of a date of birth satisfying the age requirement and a date of birth not satisfying the age requirement, in addition to the information indicating that the customer satisfies the age requirement.

10-6. The checkout apparatus according to any one of 10 to 10-5, further including:

a voice recording unit that starts to record voice in a case where the determination unit determines that the customer does not satisfy the age requirement.

10-7. The checkout apparatus according to any one of 10 to 10-6,

wherein the determination unit includes

a first accumulation unit that accumulates a feature value of each customer who has visited a store in the past and purchased the age restricted product, and

a first determination unit that determines, when the identification information of the age restricted product is input, whether or not a customer has visited the store in the past and purchased the age restricted product on the basis of the image obtained by photographing the customer and the feature value accumulated in the first accumulation unit, and determines that the customer satisfies the age requirement in a case where the first determination unit determines that the customer has visited the store in the past and purchased the age restricted product.

10-8. The checkout apparatus according to 10-7,

wherein the determination unit includes

a second accumulation unit that accumulates a feature value and age information of a person in association with each other, and

a second determination unit that determines whether or not a customer satisfies the age requirement on the basis of the image obtained by photographing the customer and the feature value accumulated in the second accumulation unit, in a case where the first determination unit does not determine that the customer has visited the store in the past and purchased the age restricted product.

10-9. The checkout apparatus according to 10-7 or 10-8,

wherein the first accumulation unit accumulates the feature value in association with a latest visit date of each customer, and

wherein the checkout apparatus further includes an updating unit that eliminates the feature value in which the number of days since the latest visit date up until a certain day exceeds a predetermined value, from the first accumulation unit.

11. A checkout method executed by a computer, the method including:

a product identification information reception step of receiving an input of identification information of a product;

a determination step of determining whether or not a customer satisfies an age requirement by analyzing an image obtained by photographing the customer when the identification information of an age restricted product is input; and

a notification step of outputting a warning for prompting age verification in a case where it is determined in the determination step that the customer does not satisfy the age requirement, and not outputting the warning in a case where it is determined in the determination step that the customer satisfies the age requirement.

11-2. The checkout method according to 11, executed by the computer, the method further including:

a user input reception step of performing, in a case where it is determined in the determination step that the customer does not satisfy the age requirement, a verification process of receiving an input to the effect that the customer satisfies the age requirement or an input to the effect that the customer does not satisfy the age requirement from a user.

11-3. The checkout method according to 11, executed by the computer, the method further including:

a user input reception step of performing a verification process of receiving an input to the effect that age verification has been performed on the customer from a user, in a case where it is determined in the determination step that the customer does not satisfy the age requirement.

11-4. The checkout method according to 11-2 or 11-3, executed by the computer, the method further including: a restriction step of stopping a checkout process until the input is received in the user input reception step, in a case where it is determined in the determination step that the customer does not satisfy the age requirement.

11-5. The checkout method according to any one of 11 to 11-4,

wherein in the notification step, at least one of a date of birth satisfying the age requirement and a date of birth not satisfying the age requirement is output, in addition to the warning.

11-6. The checkout method according to any one of 11 to 11-5, executed by the computer, the method further including:

a voice recording step of starting to record voice in a case where it is determined in the determination step that the customer does not satisfy the age requirement.

11-7. The checkout method according to any one of 11 to 11-6,

wherein the computer accumulates a feature value of each customer who has visited a store in the past and purchased the age restricted product, and

wherein in the determination step, it is determined, when the identification information of the age restricted product is input, whether or not a customer has visited the store in the past and purchased the age restricted product on the basis of the image obtained by photographing the customer and the accumulated feature value, and it is determined that the customer satisfies the age requirement in a case where it is determined that the customer has visited the store in the past and purchased the age restricted product.

11-8. The checkout method according to 11-7,

wherein the computer accumulates a feature value and age information of a person in association with each other, and

wherein in the determination step, it is determined whether or not a customer satisfies the age requirement on the basis of the image obtained by photographing the customer and the feature value associated with the age information, in a case where it is not determined that the customer has visited the store in the past and purchased the age restricted product.

11-9. The checkout method according to 11-7 or 11-8,

wherein the computer accumulates a feature value of each customer who has visited a store in the past and purchased the age restricted product in association with a latest visit date of each customer, and

wherein the checkout method includes causing the computer to further perform an updating step of eliminating the feature value in which the number of days since the latest visit date up until a certain day exceeds a predetermined value.

12. A program causing a computer to function as:

a product identification information reception unit that receives an input of identification information of a product;

a determination unit that determines whether or not a customer satisfies an age requirement by analyzing an image obtained by photographing the customer when the identification information of an age restricted product is input; and

a notification unit that outputs a warning for prompting age verification in a case where the determination unit determines that the customer does not satisfy the age requirement, and does not output the warning in a case where the determination unit determines that the customer satisfies the age requirement.

12-2. The program according to 12, causing the computer to further function as:

a user input reception unit that performs, in a case where the determination unit determines that the customer does not satisfy the age requirement, a verification process of receiving an input to the effect that the customer satisfies the age requirement or an input to the effect that the customer does not satisfy the age requirement from a user.

12-3. The program according to 12, causing the computer to further function as:

a user input reception unit that performs a verification process of receiving an input to the effect that age verification has been performed on the customer from a user, in a case where the determination unit determines that the customer does not satisfy the age requirement.

12-4. The program according to 12-2 or 12-3, causing the computer to further function as:

a restriction unit that stops a checkout process until the user input reception unit receives the input, in a case where the determination unit determines that the customer does not satisfy the age requirement.

12-5. The program according to any one of 12 to 12-4,

wherein the notification unit is caused to output at least one of a date of birth satisfying the age requirement and a date of birth not satisfying the age requirement, in addition to the warning.

12-6. The program according to any one of 12 to 12-5, causing the computer to further function as:

a voice recording unit that starts to record voice in a case where the determination unit determines that the customer does not satisfy the age requirement.

12-7. The program according to any one of 12 to 12-6,

wherein the determination unit is caused to function as

a first accumulation unit that accumulates a feature value of each customer who has visited a store in the past and purchased the age restricted product, and

a first determination unit that determines, when the identification information of the age restricted product is input, whether or not a customer has visited the store in the past and purchased the age restricted product on the basis of the image obtained by photographing the customer and the feature value accumulated in the first accumulation unit, and determines that the customer satisfies the age requirement in a case where the first determination unit determines that the customer has visited the store in the past and purchased the age restricted product.

12-8. The program according to 12-7,

wherein the determination unit is caused to function as

a second accumulation unit that accumulates a feature value and age information of a person in association with each other, and

a second determination unit that determines whether or not a customer satisfies the age requirement on the basis of the image obtained by photographing the customer and the feature value accumulated in the second accumulation unit, in a case where the first determination unit does not determine that the customer has visited the store in the past and purchased the age restricted product.

12-9. The program according to 12-7 or 12-8,

wherein the first accumulation unit is caused to accumulate the feature value in association with a latest visit date of each customer, and

wherein the program causing the computer to further function as an updating unit that eliminates the feature value in which the number of days since the latest visit date up until a certain day exceeds a predetermined value, from the first accumulation unit.

13. A checkout method including causing a computer to perform:

a product identification information reception step of receiving an input of identification information of a product;

a determination step of determining whether or not a customer satisfies an age requirement by analyzing an image obtained by photographing the customer when the identification information of an age restricted product is input; and

a notification step of outputting information indicating that the customer satisfies the age requirement, in a case where it is determined in the determination step that the customer satisfies the age requirement.

13-2. The checkout method according to 13, further including:

causing the computer to perform a user input reception step of performing, in a case where the computer determines that the customer does not satisfy the age requirement in the determination step, a verification process of receiving an input to the effect that the customer satisfies the age requirement or an input to the effect that the customer does not satisfy the age requirement from a user.

13-3. The checkout method according to 13, further including:

causing the computer to perform a user input reception step of performing a verification process of receiving an input to the effect that age verification has been performed on the customer from a user, in a case where the computer determines that the customer does not satisfy the age requirement in the determination step.

13-4. The checkout method according to 13-2 or 13-3, further including:

causing the computer to perform a restriction step of stopping a checkout process until the input is received in the user input reception step, in a case where the computer determines that the customer does not satisfy the age requirement in the determination step.

13-5. The checkout method according to any one of 13 to 13-4,

wherein in the notification step, at least one of a date of birth satisfying the age requirement and a date of birth not satisfying the age requirement is output, in addition to the information indicating that the customer satisfies the age requirement.

13-6. The checkout method according to any one of 13 to 13-5, further including:

causing the computer to perform a voice recording step of starting to record voice in a case where the computer determines that the customer does not satisfy the age requirement in the determination step.

13-7. The checkout method according to any one of 13 to 13-6,

wherein the computer accumulates a feature value of each customer who has visited a store in the past and purchased the age restricted product, and

wherein in the determination step, it is determined, when the identification information of the age restricted product is input, whether or not a customer has visited the store in the past and purchased the age restricted product on the basis of the image obtained by photographing the customer and the accumulated feature value, and it is determined that the customer satisfies the age requirement in a case where it is determined that the customer has visited the store in the past and purchased the age restricted product.

13-8. The checkout method according to 13-7,

wherein the computer accumulates a feature value and age information of a person in association with each other, and

wherein in the determination step, it is determined whether or not a customer satisfies the age requirement on the basis of the image obtained by photographing the customer and the feature value associated with the age information, in a case where it is not determined that the customer has visited the store in the past and purchased an age restricted product.

13-9. The checkout method according to 13-7 or 13-8,

wherein the computer accumulates a feature value of each customer who has visited a store in the past and purchased the age restricted product in association with a latest visit date of each customer, and

wherein the checkout method includes causing the computer to further perform an updating step of eliminating the feature value in which the number of days since the latest visit date up until a certain day exceeds a predetermined value.

14. A program causing a computer to function as:

a product identification information reception unit that receives an input of identification information of a product;

a determination unit that analyzes an image obtained by photographing a customer and determines whether or not the customer satisfies an age requirement when the identification information of an age restricted product is input; and

a notification unit that outputs information indicating that the customer satisfies the age requirement, in a case where the determination unit determines that the customer satisfies the age requirement.

14-2. The program according to 14, causing the computer to further function as:

a user input reception unit that performs, in a case where the determination unit determines that the customer does not satisfy the age requirement, a verification process of receiving an input to the effect that the customer satisfies the age requirement or an input to the effect that the customer does not satisfy the age requirement from a user.

14-3. The program according to 14, causing the computer to further function as:

a user input reception unit that performs a verification process of receiving an input to the effect that age verification has been performed on the customer from a user, in a case where the determination unit determines that the customer does not satisfy the age requirement.

14-4. The program according to 14-2 or 14-3, causing the computer to further function as:

a restriction unit that stops a checkout process until the user input reception unit receives the input, in a case where the determination unit determines that the customer does not satisfy the age requirement.

14-5. The program according to any one of 14 to 14-4,

wherein the notification unit is caused to output at least one of a date of birth satisfying the age requirement and a date of birth not satisfying the age requirement, in addition to the information indicating that the customer satisfies the age requirement.

14-6. The program according to any one of 14 to 14-5, causing the computer to further function as:

a voice recording unit that starts to record voice in a case where the determination unit determines that the customer does not satisfy the age requirement.

14-7. The program according to any one of 14 to 14-6,

wherein the determination unit is caused to function as

a first accumulation unit that accumulates a feature value of each customer who has visited a store in the past and purchased the age restricted product, and

a first determination unit that determines, when the identification information of the age restricted product is input, whether or not a customer has visited the store in the past and purchased the age restricted product on the basis of the image obtained by photographing the customer and the feature value accumulated in the first accumulation unit, and determines that the customer satisfies the age requirement in a case where the first determination unit determines that the customer has visited the store in the past and purchased the age restricted product.

14-8. The program according to 14-7,

wherein the determination unit is caused to function as

a second accumulation unit that accumulates a feature value and age information of a person in association with each other, and

a second determination unit that determines whether or not a customer satisfies the age requirement on the basis of the image obtained by photographing the customer and the feature value accumulated in the second accumulation unit, in a case where the first determination unit does not determine that the customer has visited the store in the past and purchased the age restricted product.

14-9. The program according to 14-7 or 14-8,

wherein the first accumulation unit is caused to accumulate the feature value in association with a latest visit date of each customer, and

wherein the program causing the computer to further function as an updating unit that eliminates the feature value in which the number of days since the latest visit date up until a certain day exceeds a predetermined value, from the first accumulation unit.

The application is based on Japanese Patent Application No. 2015-059434 filed on Mar. 23, 2015, the content of which is incorporated herein by reference.

1. A checkout apparatus comprising:
a product identification information reception unit that receives an input of identification information of a product;
a determination unit that determines whether or not a customer satisfies an age requirement by analyzing an image of the customer when the identification information of an age restricted product is input; and
a notification unit that outputs a warning for prompting age verification in a case where the determination unit determines that the customer does not satisfy the age requirement.

2. The checkout apparatus according to claim 1, further comprising:
a user input reception unit that performs, in a case where the determination unit determines that the customer does not satisfy the age requirement, a verification process of receiving an input to the effect that the customer satisfies the age requirement or an input to the effect that the customer does not satisfy the age requirement from a user.

3. The checkout apparatus according to claim 1, further comprising: a user input reception unit that performs a verification process of receiving an input to the effect that age verification has been performed on the customer from a user, in a case where the determination unit determines that the customer does not satisfy the age requirement.

4. The checkout apparatus according to claim 2, further comprising:
a restriction unit that stops a checkout process until the user input reception unit receives the input, in a case where the determination unit determines that the customer does not satisfy the age requirement.

5. The checkout apparatus according to claim 1,
wherein the notification unit outputs at least one of a date of birth satisfying the age requirement and a date of birth not satisfying the age requirement, in addition to the warning.

6. The checkout apparatus according to claim 1, further comprising:
a voice recording unit that starts to record voice in a case where the determination unit determines that the customer does not satisfy the age requirement.

7. The checkout apparatus according to claim 1,
wherein the determination unit comprises
a first accumulation unit that accumulates a feature value of each customer who has visited a store in the past and purchased the age restricted product, and
a first determination unit that determines, when the identification information of the age restricted product is input, whether or not a customer has visited the store in the past and purchased the age restricted product on the basis of the image of the customer and the feature value accumulated in the first accumulation unit, and determines that the customer satisfies the age requirement in a case where the first determination unit determines that the customer has visited the store in the past and purchased the age restricted product.

8. The checkout apparatus according to claim 7,
wherein the determination unit includes
a second accumulation unit that accumulates a feature value and age information of a person in association with each other, and
a second determination unit that determines whether or not a customer satisfies the age requirement on the basis of the image of the customer and the feature value accumulated in the second accumulation unit, in a case where the first determination unit does not determine that the customer has visited the store in the past and purchased the age restricted product.

9. The checkout apparatus according to claim 7,
wherein the first accumulation unit accumulates the feature value in association with a latest visit date of each customer, and
wherein the checkout apparatus further comprises:
an updating unit that eliminates the feature value in which the number of days since the latest visit date up until a certain day exceeds a predetermined value, from the first accumulation unit.

10. A checkout apparatus comprising:
a product identification information reception unit that receives an input of identification information of a product;
a determination unit that determines whether or not a customer satisfies an age requirement by analyzing an image of the customer when the identification information of an age restricted product is input; and
a notification unit that outputs information indicating that the customer satisfies the age requirement, in a case where the determination unit determines that the customer satisfies the age requirement.

11. A checkout method executed by a computer, the method comprising:
a product identification information reception step of receiving an input of identification information of a product;
a determination step of determining whether or not a customer satisfies an age requirement by analyzing an image of the customer when the identification information of an age restricted product is input; and
a notification step of outputting a warning for prompting age verification in a case where it is determined in the determination step that the customer does not satisfy the age requirement, and not outputting the warning in a case where it is determined in the determination step that the customer satisfies the age requirement.

12.-14. (canceled)
